(19) United States
(12) Patent Application Publication
(10) Pub. No.: US 2018/0199002 A1
(43) Pub. Date: Jul. 12, 2018

(54) VIDEO PROCESSING APPARATUS AND VIDEO PROCESSING METHOD COOPERATING WITH TELEVISION BROADCASTING SYSTEM

(71) Applicant: MStar Semiconductor, Inc., Hsinchu Hsien (TW)

(72) Inventors: Yi-Shin Tung, Hsinchu Hsien (TW); Tzu-Jung Huang, Hsinchu Hsien (TW); He-Yuan Lin, Hsinchu Hsien (TW)

(21) Appl. No.: 15/713,807

(22) Filed: Sep. 25, 2017

(30) Foreign Application Priority Data
Jan. 9, 2017 (TW) 106100621

(51) Int. Cl. H04N 5/445; H04N 21/431; H04N 21/462; H04N 21/426

(52) U.S. Cl. CPC H04N 5/44591; H04N 21/4316; H04N 21/42638; H04N 21/42676; H04N 2005/44595; H04N 21/4622

(57) ABSTRACT

A video processing apparatus includes a down-sampling circuit, a combining circuit, a metadata generating circuit, and an encoder. The down-sampling circuit down-samples P videos according to predetermined picture layout information of K picture layouts. Each of the videos corresponds to a television program. The combining circuit combines the P down-sampled videos according to the predetermined picture layout information to generate combined videos corresponding to the K picture layouts. The metadata generating circuit generates metadata that describes television program information corresponding to the picture layouts according to the predetermined picture layout information. The encoder encodes the combined videos and the metadata to image data that conforms to a predetermined broadcast format for a television broadcasting system to broadcast.

This application claims the benefit of Taiwan application Serial No. 106100621, filed Jan. 9, 2017, the subject matter of which is incorporated herein by reference.

### BACKGROUND OF THE INVENTION

### Field of the Invention

The invention relates in general to a television system, and more particularly to a technology capable of displaying videos of multiple television programs in a same picture.

### Description of the Related Art

Televisions are essential hardware equipments in most modern households. In response to the ever-increasing number of television channels, providing a clear and convenient program menu helps users to quickly browse television programs currently being played on different channels instead of having to search for a desired program by switching one channel after another. Thus, large amounts of time may be saved for the users.

A “dynamic television wall” is one current popular program menu model—a picture is divided to simultaneously display real-time videos of multiple television programs on a screen. For example, as shown in FIG. 1, the picture on a screen may be divided into two equal parts in horizontal and vertical directions, respectively, to simultaneously display real-time videos of four television programs (CH₁ to CH₄).

In many extensively applied television signal broadcasting standards, each television program is encoded to an elementary stream, and multiple elementary streams are further packaged into one transport stream that is then broadcasted through the same frequency band. A television chip of a receiver at least includes a tuner. When the tuner is set to receive data in a predetermined frequency band, the television system may play these several television programs included the transport stream broadcasted through the predetermined frequency band. When a channel switching instruction is received and a target of the channel switching is a television program broadcasted through another frequency band, the receiving frequency band of the tuner needs to be changed and switched to the broadcasting frequency band of the transport stream of the target program.

Based on the above description, if the television programs CH₁ to CH₄ that are played simultaneously are broadcasted through four different frequency bands, the television chip of the receiver needs to include at least four tuners, each of which receiving one transport stream. Next, four sets of decoding circuits retrieve respective elementary streams of the four television programs from the respective transport streams and decode the retrieved elementary streams. An image processing circuit in the television chip then scales down picture sizes of the four television programs and combines the down-scaled pictures the to a picture shown in FIG. 1. Thus, it is known that, in order to provide sufficient tuners and decoding circuits, more powerful television chip hardware is needed as the number of programs covered by the dynamic television wall increases.

There is current a method that achieves a dynamic television wall by an entry-level television chip having only one tuner. The tuner is switched among multiple frequency bands to receive television programs broadcasted through these frequency bands in turn. However, a conversion period is needed each time the receiving frequency band of the tuner is switched, which may result an unsmooth video or intermittent pauses in the video.

### SUMMARY OF THE INVENTION

To solve the above issues, the present invention provides a video processing apparatus and a video processing method cooperating with a television broadcasting system.

A video processing apparatus cooperating with a television broadcasting system is provided according to an embodiment of the present invention. The video processing apparatus includes a down-sampling circuit, a combining circuit, a metadata generating circuit and an encoder. The television broadcasting system broadcasts P videos respectively corresponding to a plurality of television programs according to a predetermined broadcast format, where P is an integer greater than 1. The down-sampling circuit receives the P videos and predetermined picture layout information corresponding to K picture layouts, and down-samples the P videos according to the predetermined picture layout information to generate P down-sampled videos corresponding to P sub-images. The combining circuit combines the P down-sampled videos according to the predetermined picture layout information to generate a combined video including a plurality of combined pictures, each of which including at least one sub-picture. The metadata generating circuit generates metadata that describes television program information corresponding to each of the K picture layouts for the combined video according to the predetermined picture layout information. The encoder encodes the combined video and the metadata to image data that conforms to the predetermined broadcast format for the television broadcasting system to broadcast.

A video processing method cooperating with a television broadcasting system is provided according to another embodiment of the present invention. The video processing method includes: broadcasting P videos respectively corresponding to a plurality of television programs according to a predetermined broadcast format; receiving the P videos and predetermined picture layout information corresponding to K picture layouts; down-sampling the P videos according to the predetermined picture layout information to generate P down-converted videos; combining the P down-sampled videos to generate a combined video including a plurality of combined pictures; generating metadata of the combined video according to the predetermined picture layout information; and encoding the combined video and the metadata to image data that conforms to the predetermined broadcast format for the television broadcasting system to broadcast.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 (prior art) is a schematic diagram of a divided picture of a dynamic television wall;

FIG. 2 is a functional block diagram of a video processing apparatus according to an embodiment of the present invention;

FIG. 3(A) to FIG. 3(C) are a set of examples of down-sampling and combining processes performed in a space axis;

FIG. 4(A) to FIG. 4(C) are a set of examples of down-sampling and combining processes performed in both a space axis and a time axis;

FIG. 5(A) to FIG. 5(C) are a set of examples of down-sampling and combining processes performed in a time axis;

FIG. 6 is an example of a bitstream structure; and

FIG. 7 is a flowchart of an image processing method according to an embodiment of the present invention.

It should be noted that, the drawings of the present invention are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

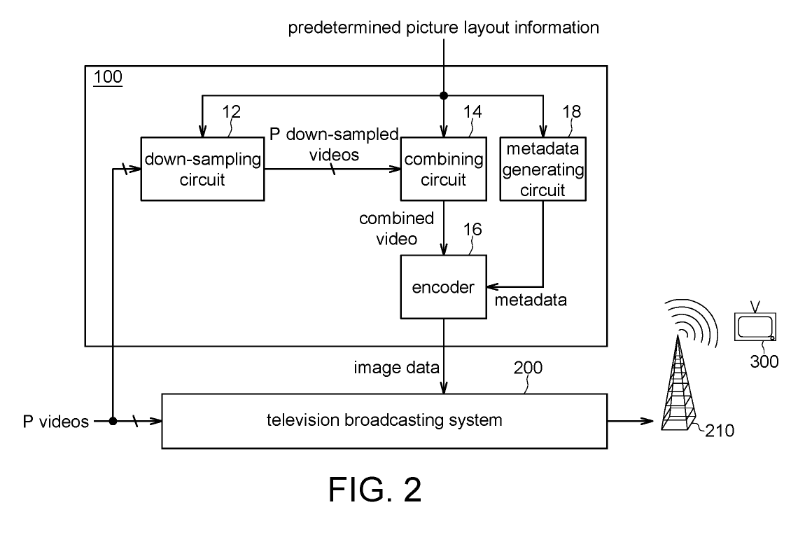

FIG. 2 shows a functional block diagram of a video processing apparatus 100 according to an embodiment of the present invention. The video processing apparatus 100 is applied to a television broadcasting system 200. The so-called television broadcasting system covers various types of systems with analog, digital or network television signal broadcasting capabilities, for example, television signal transmission stations and television signal streaming servers. The scope of the present invention is not limited to implementing the television broadcasting system 200 by a predetermined configuration or architecture. The video processing apparatus 100 includes a down-sampling circuit 12, a combining circuit 14, an encoder 16 and a metadata generating circuit 18. The video processing apparatus 100 may be an independent unit, or may be integrated in the television broadcasting system 200.

In FIG. 2, the television broadcasting system 200 receives P videos (where P is an integer greater than 1), each of which corresponding to one television program. In practice, these videos may be provided by one or multiple television service providers. The television broadcasting system 200 controls and coordinates the broadcasting of these videos to television systems at user ends. For example, the television broadcasting system 200 may encode the videos into a plurality of elementary streams, which are further packaged into a transport stream. The television broadcasting system 200 then sends one or multiple transport streams including the P videos to a television system 300 via a broadcast antenna tower 210.

The down-sampling circuit 12 of the video processing apparatus 100 also receives the P videos. In the example in FIG. 2, the P videos are bypassed to the down-sampling circuit 12 when sent into the television broadcasting system 200. The down-sampling circuit 12 down-samples the P videos according to predetermined picture layout information corresponding to K picture layouts to generate P down-sampled videos, where K is a positive integer. In practice, the predetermined picture layout information may be determined by a manager of the video processing apparatus 100 or a television service provider. The predetermined picture layout refers to an arrangement layout of the P videos in the same picture on one screen, and the definition of the K picture layouts are later described in detail in following paragraphs.

The combining circuit 14 combines the P down-sampled videos according to the same predetermined picture layout information to generate a combined video corresponding to the K picture layouts. Several examples of the predetermined picture layouts, as well as how the down-sampling circuit 12 and the combining circuit 14 operate in response to the predetermined picture layouts, are introduced below.

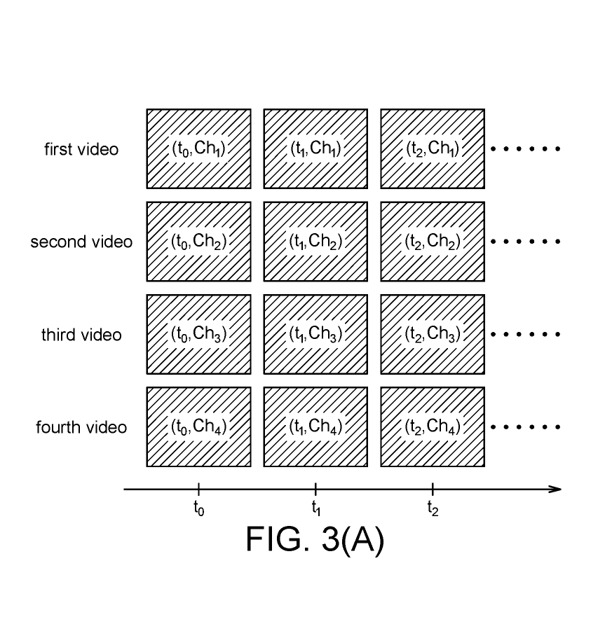

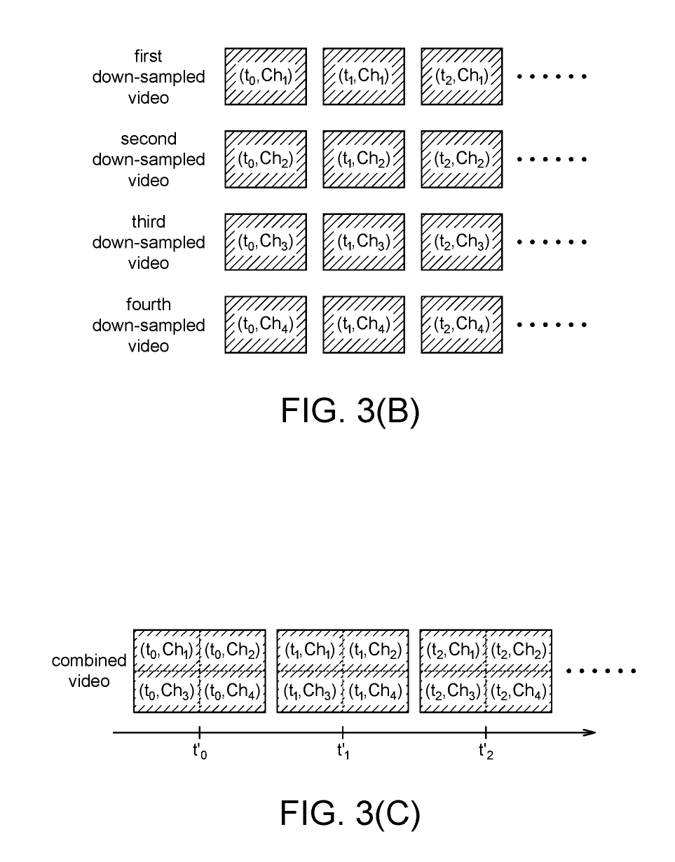

Refer to FIG. 3(A) to FIG. 3(C). In this example, P is equal to 4 and K is equal to 1. That is to say, in this example, the predetermined picture layout information includes combining four videos, and each picture in the combined video corresponds to the same picture layout. Assuming that a first video to a fourth video that the down-sampling circuit 12 receives respectively correspond to the television programs CH₁ to CH₄, and original picture sizes and frame rates of these four videos are identical. FIG. 3(A) shows a schematic diagram of an input signal of the down-sampling circuit 12. At each of the time points (t₀, t₁, t₂, . . . ), the down-sampling circuit 12 receives four pictures that are respectively from the television programs CH₁ to CH₄. Further, in this example, it is assumed that the predetermined picture layout information includes: 1) the combined video includes only one picture layout (K is equal to 1); 2) this picture layout includes 2*2 same-sized sub-pictures; and 3) from left to right and from top to bottom, these four sub-pictures respectively correspond to the television programs CH₁ to CH₄.

In response to the predetermined picture layout information that requires a combined picture to include a plurality of sub-pictures, the down-sampling circuit 12 may down-sample each of the original pictures in the first video to the fourth video respectively along the directions of the length and width of a space axis, so as to scale down the picture size to one-quarter of the original picture sizes (reducing both of the length and width by one-half). For example, if the picture size of each original picture is 1920*1080 pixels, the picture size of each down-sampled video is 960*540 pixels. FIG. 3(B) shows a schematic diagram of these four down-sampled videos.

In response to the above predetermined picture layout information, the combining circuit 14 combines four pictures of the four down-sampled videos to one single picture, where the above four pictures are sampled at the same time point. FIG. 3(C) shows a schematic diagram of an output signal of the combining circuit 14. As shown in FIG. 3(C), the combined picture that the combining circuit 14 generates at a time point t′₀ includes four sub-pictures, each of which corresponding to one television program (one of CH₁ to CH₄) at the same time point t₀. Similarly, the combined picture that the combining circuit 14 generates at the time point is similarly formed by four sub-pictures corresponding to the same time point t₁, and so forth. These sequential combined pictures then form a combined video.

In practice, the down-sampling circuit 12 may include multiple average calculating circuits to calculate average values, and may divide an original picture into multiple sets each including 2*2 pixels. The average calculating circuits determine one average value of image data (e.g., grayscale values) of four pixels in each set to generate a new set of pixel image data using that average value in order to achieve down-sampling in the space axis. The combining circuit 14 may include a frame buffer having a size of 1920*1080 pixels for the down-sampling circuit 12 to write the newly generated pixel image data therein. According to the predetermined picture layout information, the combining circuit 14 may determine an appropriate position for writing each set of new pixel image data to the frame buffer, such that the four down-sampled pictures(each in a size of 960*540 pixels) form a new combined picture in the frame buffer. Taking FIG. 3(C) for example, the combining circuit 14 may cause 960*540 sets of new pixel image data of the television program CH₁ to write in the positions in the frame buffer which correspond to the upper-left corner of the picture.

The metadata generating circuit 18 generates metadata for the combined video according to the predetermined picture layout information, wherein the metadata describes television program information corresponding to each of the K picture layouts. The television system 300 may obtain the predetermined picture layout information and/or other associated information from the metadata. For example, in addition to the numbers and position allocations of the picture layouts, the television program information described by the metadata may further include at least one type of following information: a program channel identification code corresponding to each sub-picture in each picture layout, a program provider identification code corresponding to each sub-picture, and a program type (e.g., news, travel and sports) identification code corresponding to each sub-picture.

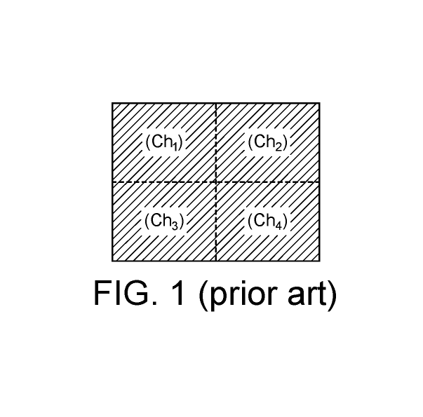

The encoder 16 encodes the combined video generated by the combining circuit 14 and the metadata generated by the metadata generating circuit 18 to image data that conforms to a predetermined broadcast format, and provides the image data to the television broadcasting system 200 to broadcast. Take an example where the television broadcasting system 200 adopts the high efficiency video coding (HEVC) specification for instance. The encoder 16 may encode the combined video and the metadata to an elementary stream, which is then packaged to a transport stream and broadcasted by the television broadcasting system 200. In other words, the format of the combined video may be the same as those of other common television programs, and may be considered as one television program and broadcasted. If the television system 300 receives, decodes and plays this television program, the associated effect conforms to the predetermined picture layout in FIG. 1 and the dynamic television wall that simultaneously displays the television programs CH₁ to CH₄. It should be noted that, even an entry-level television chip that includes only one tuner and one decoding circuit is capable of smoothly receiving and playing the dynamic television wall without switching receiving frequency bands.

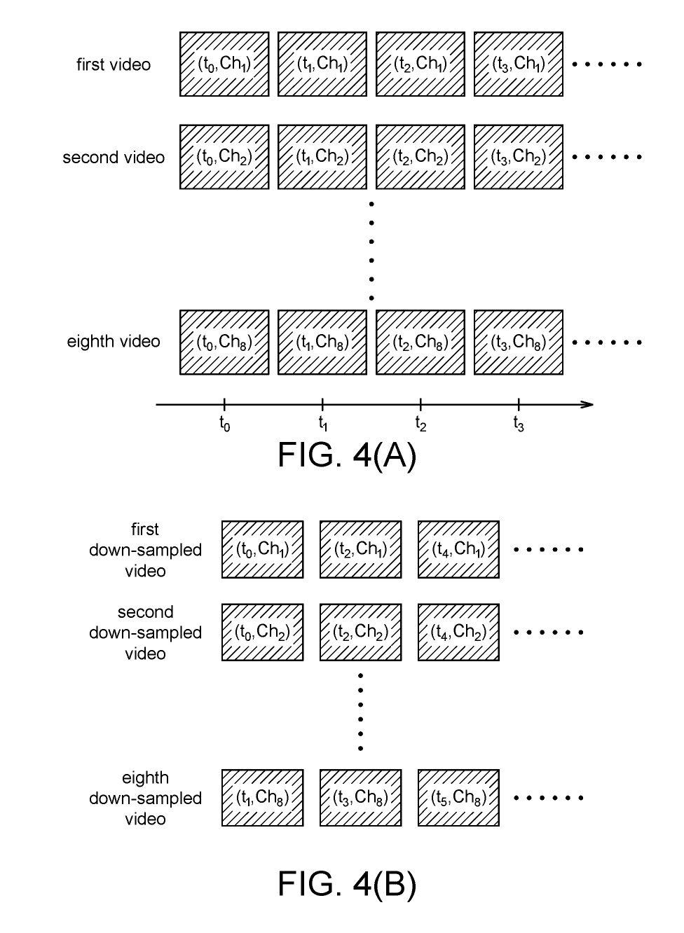

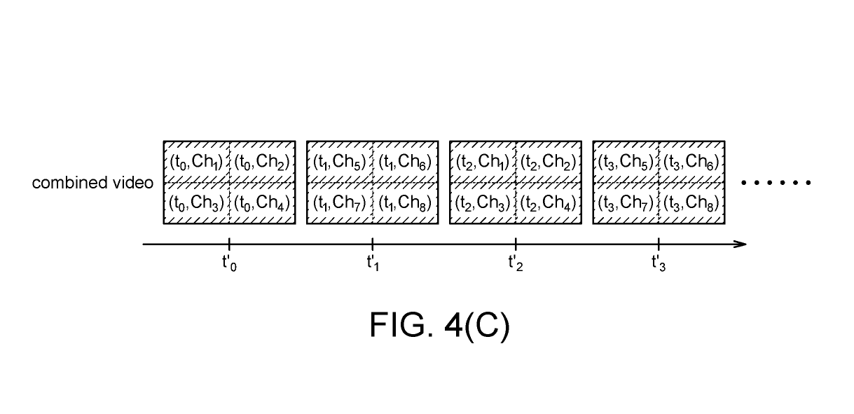

Refer to FIG. 4(A) to FIG. 4(C). In this example, P is equal to 8 and K is equal to 2. That is to say, in this example, the predetermined picture layout information requires to combine eight videos and the combined pictures in the combined video have two different picture layouts. Assume that the eight videos that the down-sampling circuit 12 receives respectively correspond to television programs CH₁ to CH₈, and original picture sizes and frame rates of these eight videos are identical. FIG. 4(A) shows a schematic diagram of an input signal of the down-sampling circuit 12. At each of the time points (t₀, t₁, t₂, . . . ), the down-sampling circuit 12 receives eight pictures that are respectively from the television programs CH₁ to CH₈. Further, in this example, the predetermined picture layout information includes: 1) the combined video includes two picture layouts; 2) each of the two picture layouts includes 2*2 same-sized sub-pictures; 3) in the first picture layout, from left to right and from top to bottom, the four sub-pictures respectively correspond to the television programs CH₁ to CH_{4,} and 4) in the second picture layout, from left to right and from top to bottom, the four sub-pictures respectively correspond to the television programs CH₅ to CH₈.

FIG. 4(B) shows a schematic diagram of eight down-sampled videos that the down-sampling circuit 12 generates in response to the above predetermined picture layout information. In this embodiment, as the two current picture layouts requires the combined picture to include a plurality of sub-pictures and the combined video needs to include multiple picture layouts (where the positive integer K is greater than 1), the down-sampling circuit 12 down-samples in both the space axis and the time axis. Thus, in addition to having reduced picture sizes, these eight down-sampled videos also have frame rates reduced to one-half of original frame rates. More specifically, in this example, the down-sampling circuit 12 keeps the pictures of the first video to the fourth video corresponding to the time points t₀, t₂, t₄, . . . , and discards the pictures of the first video to the fourth video corresponding to the time points t₁, t₃, t₅, . . . . Further, the down-sampling circuit 12 keeps the pictures of the fifth videos to the eighth videos corresponding to the time points t₁, t₃, t₅, . . . , and discards the pictures of the fifth video to the eighth video corresponding to the time points t₉, t₂, t₄, . . . .

Next, in response to the current predetermined picture layout information, the combining circuit 14 combines four pictures of the first to fourth down-sampled video at the same time point to one single picture; combines four pictures of the fifth to the eighth down-sampled video to one single picture. FIG. 4(C) shows a schematic diagram of an output signal of the combining circuit 14. The combined picture, which the combining circuit 14 generates at the time point t′₀, corresponds to the first picture layout and includes four sub-pictures respectively corresponding to the television programs CH₁ to CH₄ of the same time point t₀. The combined picture, which the combining circuit 14 generates at the time point t′₁, corresponds to the second picture layout and includes four sub-pictures respectively corresponding to the television programs CH₅ to CH₈ of the same time point The combined picture, which the combining circuit 14 generates at the time point t′₂, again corresponds to the first picture layout and includes four sub-pictures respectively corresponding to the television programs CH₁ to CH₄; the combined picture, which the combining circuit 14 generates at the time point t′₃, again corresponds to the second picture layout and includes four sub-pictures respectively corresponding to the television programs CH₅ to CH₈. The time points t′₀ to t′₃ are consecutive time points. That is to say, the combined video includes the first picture layout corresponding to the television programs CH₁ to CH₄, and the second picture layout corresponding to the television programs CH₅ to CH₈.

Similarly, the metadata generating circuit 18 generates metadata that describes television program information corresponding to the two picture layouts for the combined video according to the current predetermined picture layout information. The encoder 16 encodes the combined video and the metadata of the combined video to image data that conforms to the broadcast format of the television broadcasting system 200, and provides the image data to the television broadcasting system 200 to broadcast.

In practice, through the metadata, the television system 300 learns the predetermined picture layout information that the video processing apparatus 100 adopts, and manipulates the image data that the video processing apparatus 100 generates for desired applications. For example, the combined video data in FIG. 4(C) may be divided to be played by two dynamic television walls, one of which playing the picture including the television programs CH₁ to CH₄ and the other playing the picture including the television programs CH₅ to CH₈. Alternatively, a television system at the user end may retrieve eight sub-pictures of respective down-sampled images of the television programs CH₁ to CH₈ from the received image data, and may manipulate the sub-pictures such as recombining the sub-pictures, e.g., combining a dynamic television wall that displays the television programs CH₁, CH₃, CH₅ and CH₇.

In the foregoing embodiments, each combined picture includes 2*2 sub-pictures, which is however not to be construed as a limitation to the scope of the present invention. The predetermined picture layout information is flexible regardless of whether down-sampling is performed in the space axis or the time axis. For example, one picture layout designated by the predetermined picture layout information may include 2*3 or 4*3 sub-pictures, which do not need to be entirely same-sized.

Through the above concept, the video processing apparatus 100 and the television broadcasting system 200 may provide pictures corresponding to down-sampled videos of tens or even hundreds of television programs to the television system 300 through merely one set or several sets of image data. The television system 300 may determine the down-sampled videos corresponding to which of the television programs are to be retrieved and recombined to one or multiple new dynamic television walls. Further, the picture layout actually displayed on the screen of the television system 300 may also be determined by a user.

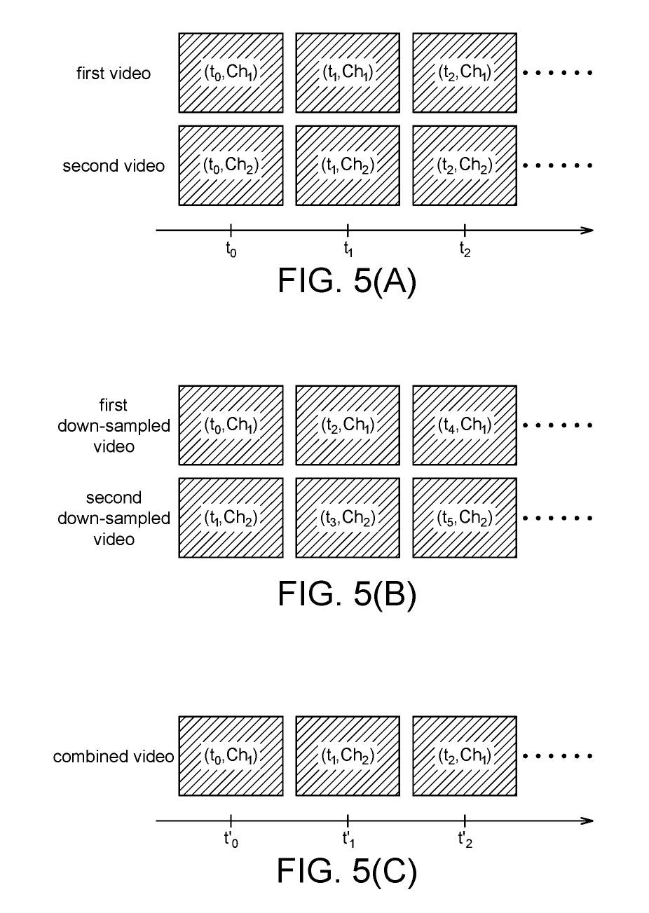

FIG. 5(A) to FIG. 5(C) show an example of another predetermined picture layout. In this example, P is equal to 2 and K is equal to 2. That is to say, in this example, the predetermined picture layout information requires to combine two videos, and the combined picture in the combined video needs to corresponding to two different picture layouts. Assume that a first video and a second video that the down-sampling circuit 12 receives respectively correspond to the television programs CH₁ to CH₂, and original picture sizes and frame rates of these two videos are identical. FIG. 5(A) shows a schematic diagram of an input signal of the down-sampling circuit 12. At each of the time points (t₀, t₁, t₂, . . . ), the down-sampling circuit 12 receives two pictures that are respectively from the television programs CH₁ to CH₂. Further, in this example, it is assumed that the predetermined picture layout information includes: 1) the combined video includes two picture layouts; 2) each of the two picture layouts includes one sub-picture; 3) the sub-picture in the first picture layout corresponds to the television program CH₁, and 4) the sub-picture in the second picture layout corresponds to the television program CH₂.

FIG. 5(B) shows a schematic diagram of two down-sampled videos that the down-sampling circuit 12 generates in response to the above predetermined picture layout information. Because the two current picture layouts do not require the combined picture to include a plurality of sub-pictures, there is no need to do down-sampling in space axis. On the other hand, as the combined video needs to include multiple picture layouts (the positive integer K is greater than 1), the down-sampling circuit 12 down-samples in the time axis, i.e., discards pictures corresponding to some of the time points. More specifically, the down-sampling circuit 12 keeps the pictures of the first video that correspond to the time points t₀, t₂, t₄, . . . , and discards the pictures of the first video that correspond to the time points t₁, t₃, t₅, . . . . Further, the down-sampling circuit 12 keeps the pictures of the second video that correspond to the time points t₁, t₃, t₅, . . . , and discards the pictures of the second video that correspond to the time points t₀, t₂, t₄, . . . . FIG. 5(C) shows a combined video that the combining circuit 14 generates in response to the predetermined picture layout information.

It should be noted that, technical details of down-sampling a video in the space axis or the time axis according to a predetermined ratio are generally known to one person skilled in the art, and shall be omitted herein. The combining circuit 14 may be implemented by various types of circuits, e.g., a programmable logic gate array, an application-specific integrated circuit, a microcontroller, a microprocessor, and a digital signal processor. Further, the combining circuit 14 may be designed to complete its tasks through executing a processor command stored in a memory.

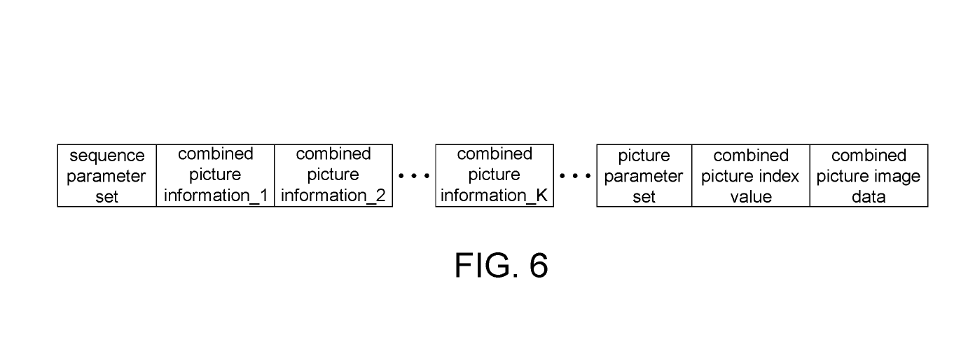

In one embodiment, the metadata from the metadata generating circuit 18 includes K index values, which respectively point to the K picture layouts. For example, the metadata generating circuit 18 may have the index value 1 point to the first picture layout, the second index value 2 point to the second picture layout, and so forth. Taking FIG. 5(C) for example, the combined pictures generated at the time points t′₀, t′₂, t′₄, . . . are assigned with the index value 1 as they correspond to the first picture layout, and the combined pictures generated at the time points t′₁, t′₃, t′₅, . . . are assigned with the index value 2 as they correspond to the first picture layout. Correspondingly, the encoder 16 may encode the combined video and the metadata of the combined video to have a bitstream structure, and write the television program information to a first level of the bitstream structure and the multiple index values to a second level of the bitstream structure. For example, the first level corresponds to multiple consecutive pictures, and the second level corresponds to one single picture. Taking the HEVC standard for example, the encoder 16 may encode the television program information corresponding to K pictures to K sets of supplemental enhancement information (SEI) that is then placed into a parameter set of a sequence level, in a way that the multiple consecutive pictures may share the K sets of television program information. Similarly, through the form of SEI, the encoder 16 may write the multiple index values into a parameter set of a picture level, such that a headend of image data of each picture carries an index value that points to the picture layout to which the picture corresponds. As shown in FIG. 6, combined picture information 1˜K follow the sequence parameter set, and the combined picture index values are placed between the picture parameter set and the image data.

One benefit of “writing the television program information and the index values to different levels” is, the video processing apparatus 100 is not required to record the associated television program information in the metadata of each picture. By obtaining the metadata in a higher level using the index value of each picture, the television system can obtain the detailed information of the picture. Thus, the data size of the data transmitted from the television broadcasting system 200 to the television system 300 may be effectively reduced.

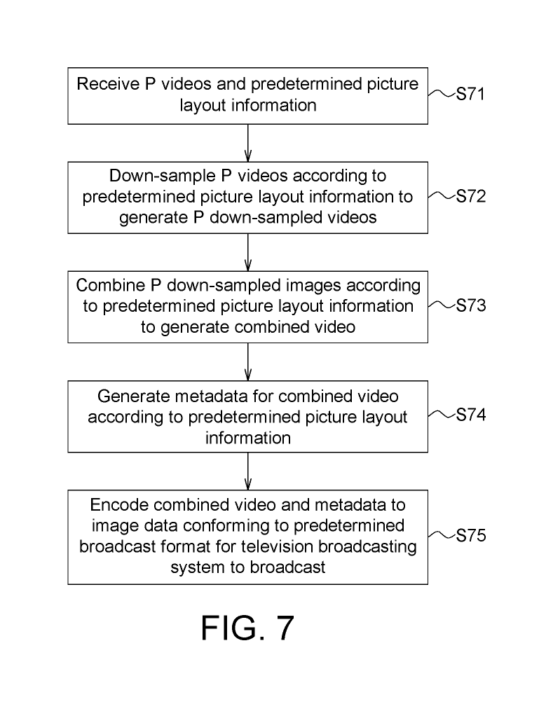

A video processing method operating with a television broadcasting system is further provided according to another embodiment of the present invention. FIG. 7 shows a flowchart of the video processing method. The television broadcasting system broadcasts P videos according to a predetermined broadcast format. Each of the videos corresponds to one television program, and P is an integer greater than 1. Referring to FIG. 7, in step S71, the P videos and predetermined picture layout information corresponding to K picture layouts are received, where K is a positive integer greater than 1. In step S72, the P videos are down-sampled according to the predetermined picture layout information to generate P down-sampled videos. In step S73, the P down-sampled videos are combined according to the predetermined picture layout information to generate a combined video corresponding to the K picture layouts. In step S74, metadata is generated for the combined video according to the predetermined picture layout information; the metadata is to describe the television program information corresponding to each of the K picture layouts. In step S75, the combined video and the metadata are encoded to image data that conforms to the predetermined broadcast format for the television broadcasting system to broadcast.

One person skilled in the art can understand that, the operation variations in the description associated with the video processing apparatus 100 are applicable to the image processing method in FIG. 7, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video processing apparatus, operating with a television broadcasting system that broadcasts P videos in a predetermined broadcast format, each of the P videos corresponding to a television program, P being an integer greater than 1, the video processing apparatus comprising:
a down-sampling circuit, receiving the P videos, down-sampling the P videos according to predetermined picture layout information corresponding to K types of picture layouts to generate P down-sampled videos, where K is a positive integer;
a combining circuit, coupled to the down-sampling circuit, combining the P down-sampled videos according to the predetermined picture layout information to generate a combined video comprising a plurality of combined pictures, wherein the P down-sampled videos correspond to P sub-pictures and each of the combined pictures comprises at least one sub-picture;
a metadata data generating circuit, generating metadata for the combined video according to the predetermined picture layout information, the metadata describing television program information of each of the K picture layouts and
an encoder, coupled to the combining circuit and the metadata generating circuit, encoding the combined video and the metadata to a set of image data that conforms to the predetermined broadcast format of the television broadcasting system.

2. The video processing apparatus according to claim 1, wherein the down-sampling circuit down-samples in a space axis when one of the K picture layouts requires a combined picture to comprise a plurality of sub-pictures.

3. The video processing apparatus according to claim 1, wherein when the positive integer K is greater than 1, the down-sampling circuit down-samples in a time axis in a way that the combining circuit generates a first combined picture at a first time point and generates a second combined picture at a second time point, the first combined picture and the second combined picture respectively corresponding to different picture layouts in the K picture layouts.

4. The video processing apparatus according to claim 1, wherein when one of the K picture layouts requires a combined picture to comprise a plurality of sub-pictures, where the positive integer K is greater than 1, the down-sampling circuit down-samples in both a space axis and a time axis.

5. The video processing apparatus according to claim 1, wherein the predetermined broadcasting format is a transport stream, and the encoder encodes the combined video and the metadata into an elementary stream.

6. The video processing apparatus according to claim 1, wherein the metadata further comprises K index values each pointing to one of the K picture layouts; the encoder encodes the combined video and the metadata to have a bitstream structure, writes the television program information of each of the picture layouts into a first level of the bitstream structure and writes the K index values into a second level of the bitstream structure.

7. The video processing apparatus according to claim 6, wherein the first level of the bitstream structure corresponds to a plurality of consecutive combined pictures and the second level of the bitstream structure corresponds to a single combined picture; the encoder encodes such that each of the combined pictures in the combined video carries one of the K index values.

8. The video processing apparatus according to claim 1, wherein the television program information corresponding to each of the picture layouts described by the metadata comprises at least one of the following information: a program channel identification code corresponding to each sub-picture, a program provider identification code corresponding to each sub-picture and a program type identification code corresponding to each sub-picture.

9. A video processing method, operating with a television broadcasting system that broadcasts P videos in a predetermined broadcast format, each of the P videos corresponding to a television program, P being an integer greater than 1, the video processing method comprising:
a) receiving the P videos and predetermined picture layout corresponding to K types of picture layouts, where K is a positive integer;
b) down-sampling the P videos according to predetermined picture layout information to generate P down-sampled videos,
c) combining the P down-sampled videos according to the predetermined picture layout information to generate a combined video comprising a plurality of combined pictures, wherein the P down-sampled videos correspond to P sub-pictures and each of the combined pictures comprises at least one sub-picture;
d) generating metadata for the combined video according to the predetermined picture layout information, the metadata describing television program information of each of the K picture layouts; and
e) encoding the combined video and the metadata to a set of image data that conforms to the predetermined broadcast format of the television broadcasting system.

10. The video processing method according to claim 9, wherein when one of the K picture layouts requires a combined picture to comprise a plurality of sub-pictures, step (b) is performed in a space axis.

11. The video processing method according to claim 9, wherein when the positive integer K is greater than 1, step (b) is performed in a time axis, and step (c) comprises:
generating a first combined picture at a first time point and a second combined picture at a second time point, the first combined picture and the second combined picture respectively corresponding to different picture layouts in the K picture layouts.

12. The video processing method according to claim 9, wherein when one of the K picture layouts requires a combined picture to comprise a plurality of sub-pictures and the positive integer K is greater than 1, step (b) is performed in both a time axis and space axis.

13. The video processing method according to claim 9, wherein the metadata generated in step (d) comprises:
K sets of picture layout information that describes television program information corresponding to each of the K picture layouts; and
K index values, each pointing to one of the K picture layouts;
wherein, step (e) comprises encoding the combined video and the metadata to have a bitstream structure, writing the television program information of each of the picture layouts into a first level of the bitstream structure and writing the K index values into a second level of the bitstream structure.

14. The video processing method according to claim 13, wherein the first level of the bitstream structure corresponds to a plurality of consecutive combined pictures and the second level of the bitstream structure corresponds to a single combined picture; step (e) comprises encoding such that each of the combined pictures in the combined video to carry one of the K index values.
